(19) United States
(12) Patent Application Publication
(10) Pub. No.: US 2013/0261515 A1
(43) Pub. Date: Oct. 3, 2013

(54) APPARATUS AND METHOD FOR ROTATION REHABILITATION TREATMENT USING VIBRATION

(71) Applicant: ELECTRONICS AND TELECOMMUNICATIONS RESEARCH IN, Daejeon (KR)

(72) Inventors: Byoung Gun CHOI, Daegu (KR); Hyung-Il PARK, Daejeon (KR); Sung Weon KANG, Daejeon (KR); Chang Hee HYOUNG, Daejeon (KR); In Gi LIM, Daejeon (KR); Tae Wook KANG, Daejeon (KR); Jung Hwan HWANG, Daejeon (KR); Kyung Soo KIM, Daejeon (KR); Jung Bum KIM, Daejeon (KR); Sung Eun KIM, Seoul (KR); Kyung Hwan PARK, Daejeon (KR); Tae Young KANG, Daejeon (KR)

(73) Assignee: Electronics and Telecommunications Research Institute, Daejeon (KR)

(21) Appl. No.: 13/660,949

(22) Filed: Oct. 25, 2012

(30) Foreign Application Priority Data
Apr. 3, 2012 (KR) 10-2012-0034262

(51) Int. Cl. A61H 1/00

(52) U.S. Cl. 601/46

(57) ABSTRACT

The present disclosure enables a user to intuitively recognize a rotation direction of a rehabilitation exercise by giving preset stimuli to a body of the user by using a vibration of the haptic device until the body of the user rotates up to a target point.

### CROSS-REFERENCE TO RELATED APPLICATIONS

This application is based on and claims priority from Korean Patent Application No. 10-2012-0034262, filed on Apr. 3, 2012, with the Korean Intellectual Property Office, the disclosure of which is incorporated herein in its entirety by reference.

### TECHNICAL FIELD

The present disclosure relates to an apparatus and a method for a rotation rehabilitation treatment using a vibration, and more particularly to an apparatus and a method for a rotation rehabilitation treatment using a vibration, capable of enabling a user to intuitively recognize a rotation direction of a rehabilitation exercise by applying preset stimuli to a user body until the user body rotates up to a target point by using vibration of a haptic device.

### BACKGROUND

A patient performs a rehabilitation treatment by moving a joint, and the like, according to a direction or a strength directed by a rehabilitation therapist or a physical therapist beside the patient. The rehabilitation therapist helps the rehabilitation treatment of the patient while observing a condition or a rehabilitation treatment process of the patient.

However, there is a case where the rehabilitation therapist is not always with the patient, and the patient needs to continue the rehabilitation treatment after leaving a hospital or by himself/herself. The patient performs the rehabilitation treatment with viewing a rehabilitation treatment guide provided by the rehabilitation therapist. In this case, the patient cannot intuitively recognize how to perform the rehabilitation treatment.

To this end, a rehabilitation treatment using a patch among the rehabilitation treatment methods in the related art will be described.

FIG. 1 is a diagram illustrating an example of a rehabilitation treatment method in the related art.

As illustrated in FIG. 1, in the rehabilitation treatment method in the related art, the rehabilitation treatment is performed by a method of bending or stretching a joint by using a patch 101. A patient 100 may perform the self rehabilitation treatment by recognizing a tensile force of the patch 101 attached to an elbow.

In the rehabilitation treatment method in the related art, the patient 100 may simply recognize only the tensile force of the patch 101. The rehabilitation treatment method in the related art may not be applied to a case where the rehabilitation treatment of the patient 100 is required to perform a rotational movement.

As described above, the patient 100 does not know a direction in which the joint needs to move or a degree of the strength by which the joint needs to move. According to the rehabilitation treatment method in the related art, the patient 100 may perform the rehabilitation treatment, but cannot perform the rehabilitation treatment in an optimal direction nor strongly, thereby causing a delay of the rehabilitation treatment.

### SUMMARY

The present disclosure has been made in an effort to provide an apparatus and a method for a rotation rehabilitation treatment using a vibration, which are capable of enabling a user to intuitively recognize a rotation direction of a rehabilitation exercise by giving preset stimuli to a user body until the user body rotates up to a target point by using a vibration of a haptic device.

Further, the present disclosure has been made in an effort to provide an apparatus and a method for a rotation rehabilitation treatment using a vibration, capable of helping a user to intuitively rotate in a correct posture with a desired rotation angle by comparing a photographed body movement and a normal body movement, feeding back a difference between the photographed body movement and the normal body movement, and vibrating a haptic device by the fed-back difference.

An exemplary embodiment of the present disclosure provides an apparatus for a rotation rehabilitation treatment using a vibration, including: a vibration unit including a plurality of haptic devices and configured to apply different vibrations according to a rotation direction of a rehabilitation exercise while being attached to a body of a user; and a control unit configured to determine the rotation direction of the rehabilitation exercise according to preset rehabilitation exercise data so that the user rotates the body, vibrate a haptic device corresponding to the rotation direction of the rehabilitation exercise among the plurality of included haptic devices, and stop the vibration of the haptic device when a rotation in the rotation direction of the rehabilitation exercise is completed.

Another exemplary embodiment of the present disclosure provides a method for a rotation rehabilitation treatment using a vibration, including: determining a rotation direction of a rehabilitation exercise according to preset rehabilitation exercise data so that a user rotates a body; vibrating a haptic device corresponding to the determined rotation direction of the rehabilitation exercise among a plurality of haptic devices configured to apply different stimuli while being attached to the body of the user; and stopping the vibration of the haptic device corresponding to the rotation direction of the rehabilitation exercise when a rotation of the body of the user in the determined rotation direction of the rehabilitation exercise is completed.

Accordingly, the present disclosure has an effect in that a user can perform a rotational movement up to a desired movement point by giving intuitive stimuli by using the haptic devices, so as to enable a user to perform a self rehabilitation treatment without a help of a rehabilitation therapist through the rotation rehabilitation treatment apparatus including the attached haptic device.

Further, the present disclosure has an effect of helping a user to intuitively rotate with a correct posture by a desired rotation angle by comparing a photographed body movement and a normal body movement, feeding back a difference between the photographed body movement and the normal body movement, and vibrating a haptic device by the fed-back difference.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating an example of a rehabilitation treatment method in the related art.

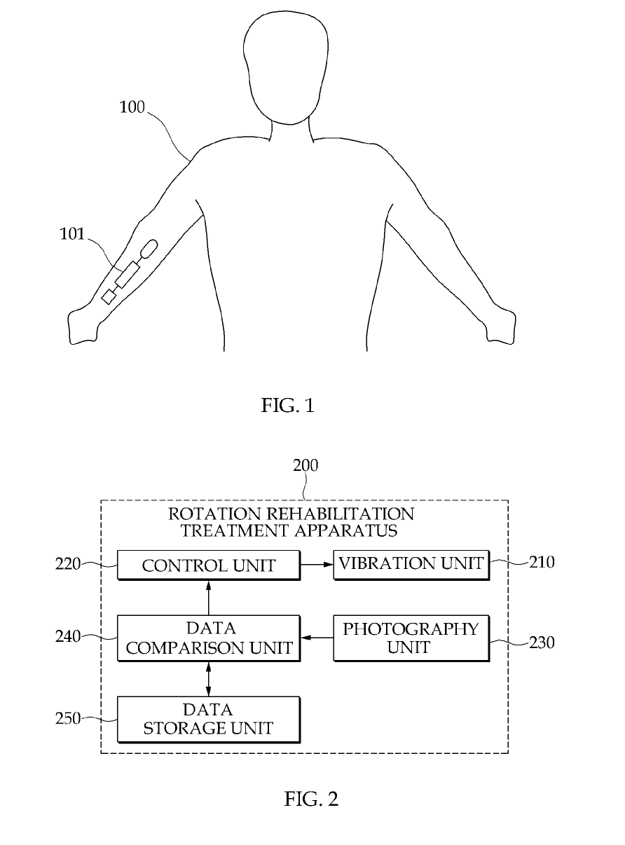

FIG. 2 is a configuration diagram illustrating an exemplary embodiment of a rotation rehabilitation treatment apparatus using a vibration according to the present disclosure.

FIG. 3 is an example diagram illustrating an exemplary embodiment of a rotation rehabilitation treatment apparatus according to the present disclosure.

FIG. 4 is an example diagram illustrating an exemplary embodiment of a state in which a rotation rehabilitation treatment apparatus according to the present disclosure is put on a wrist of a user.

FIGS. 5 and 6 are diagrams illustrating an exemplary embodiment of a process of a rotation rehabilitation treatment rotating in a clockwise/counterclockwise direction through a rotation rehabilitation treatment apparatus according to the present disclosure.

FIG. 7 is a flowchart illustrating an exemplary embodiment of a rotation rehabilitation treatment method using a vibration according to the present disclosure.

### DETAILED DESCRIPTION

In the following detailed description, reference is made to the accompanying drawing, which form a part hereof The illustrative embodiments described in the detailed description, drawing, and claims are not meant to be limiting. Other embodiments may be utilized, and other changes may be made, without departing from the spirit or scope of the subject matter presented here.

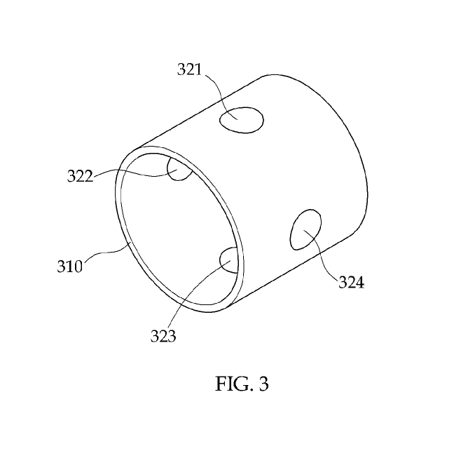

FIG. 2 is a configuration diagram illustrating an exemplary embodiment of a rotation rehabilitation treatment apparatus using a vibration according to the present disclosure.

As illustrated in FIG. 2, a rotation rehabilitation treatment apparatus 200 includes a vibration unit 210, a control unit 220, a photography unit 230, a data comparison unit 240, and a data storage unit 250.

The present disclosure relates to the rotation rehabilitation treatment apparatus 200 capable of guiding a rotational movement required for rehabilitation training related to a rotation of a body by using a vibration of a haptic device. The rotation rehabilitation treatment apparatus 200 helps a user to perform self-training by applying a vibration to the haptic device such that a movement reaches a reference point demanded in the rehabilitation training by sensing the movement of the body of the user. For example, the rotation rehabilitation treatment apparatus 200 enables the user to recognize a rotation direction by symmetrically attaching multiple haptic devices to a wrist for rotation training of the wrist among the body parts.

Hereinafter, each constitutional element of the rotation rehabilitation treatment apparatus 200 will be described. For example, the description will be made based on an arm among the body parts of the user as an example, but the present disclosure is not limited to a specific body part. The present disclosure may be applied to any body part requiring a rehabilitation rotation exercise and on which a fixing band for attachment may be put.

The vibration unit 210 includes a plurality of haptic devices. The vibration unit 210 is attached to the body of the user so as to give different stimuli according to the rotation direction of the rehabilitation exercise. The user receives pushing stimuli from the vibration of the vibration unit 210 and rotates the wrist in a direction opposite to that of the stimuli, to perform the intuitive rehabilitation treatment. The vibration unit 210 may include four haptic devices or more.

The control unit 220 determines the rotation direction of the rehabilitation exercise according to rehabilitation exercise data preset in the data storage unit 250. Further, the control unit 220 vibrates the haptic device corresponding to the rotation direction of the rehabilitation exercise among the plurality of haptic devices so as to rotate the body of the user in the determined rotation direction of the rehabilitation exercise. Here, the control unit 220 may vibrate the haptic device positioned in a diagonal direction so that the user recognizes the rotation direction of the rehabilitation exercise. Then, the control unit 220 stops the vibration of the haptic device when the rotation in the rotation direction of the rehabilitation exercise is completed.

The data storage unit 250 pre-stores a rehabilitation treatment program preset by the rehabilitation therapist, and the like. Further, the data storage unit 250 may store motion capture data, image data, and the like for a normal movement moving in a normal rotation direction of a rehabilitation exercise of each movement in the rehabilitation treatment program.

The photography unit 230 photographs a movement of the body of the user wearing a body fixing band to which the plurality of haptic devices is attached. Here, the photography unit 230 may perform a motion capture for the movement of the user. The photography unit 230 may transfer the motion captured body movement to the data comparison unit 240.

The data comparison unit 240 calculates a movement error by comparing the body movement photographed in the photography unit 230 and a body movement of the rehabilitation exercise data preset in the data storage unit 250. The data comparison unit 240 feeds back the calculated movement error to the control unit 220.

The control unit 220 determines a vibration level of the vibration unit 210 in proportion to a size of the movement error fed back from the data comparison unit 240 so that the user rotates the body by a rotation angle of the preset rehabilitation exercise data.

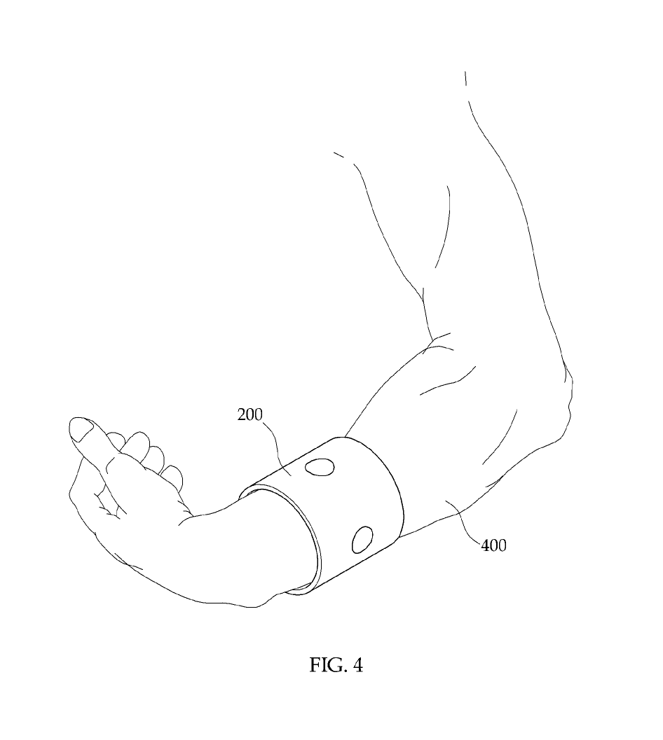

FIG. 3 is an example diagram illustrating an exemplary embodiment of the rotation rehabilitation treatment apparatus according to the present disclosure.

As illustrated in FIG. 3, the rotation rehabilitation treatment apparatus 200 may include a body fixing band 310 and four haptic devices 321 to 324 and be attached to the user. The rotation rehabilitation treatment apparatus 200 is attached to the user through the body fixing band 310.

Here, each of the haptic devices 1 to 4 321 to 324 is installed in a diagonal direction with respect to the body fixing band 310. The haptic devices 1 to 4 321 to 324 are installed at upper and lower parts of left and right sides, respectively. Not only the haptic devices 1 to 4 321 to 324, but also additional haptic devices may be installed in the body fixing band 310.

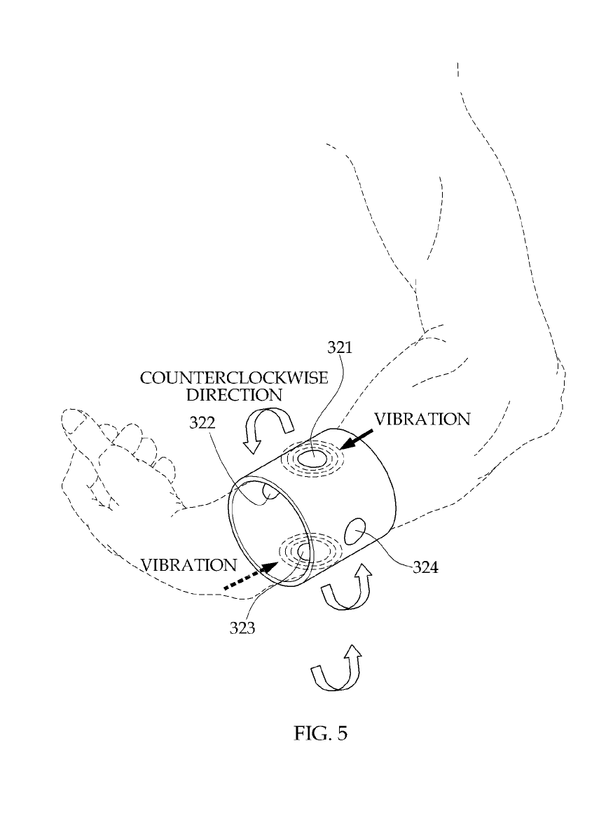

FIG. 4 is an example diagram illustrating an exemplary embodiment of a state in which the rotation rehabilitation treatment apparatus according to the present disclosure is put on the wrist of the user.

As illustrated in FIG. 4, the rotation rehabilitation treatment apparatus 200 is installed in a wrist 400 of the user. The user recognizes the rotation direction of the rehabilitation exercise by sensing a vibration applied by the vibration unit 210 while wearing the rotation rehabilitation treatment apparatus 200.

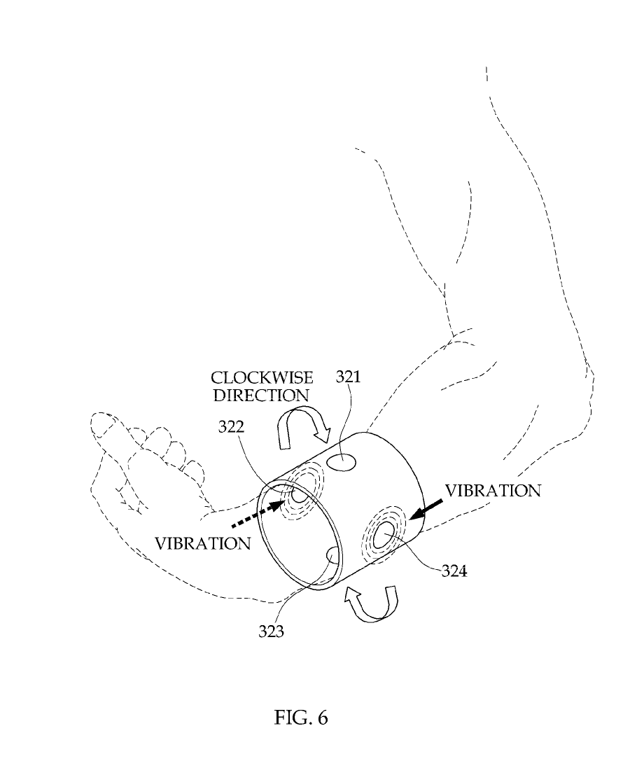

Here, a process in which the user performs a rehabilitation exercise by rotating in a counterclockwise direction or a clockwise direction will be described with reference to FIGS. 5 and 6.

FIGS. 5 and 6 are diagrams illustrating an exemplary embodiment of a process of a rotation rehabilitation treatment rotating in a counterclockwise/clockwise direction through the rotation rehabilitation treatment apparatus according to the present disclosure.

As illustrated in FIG. 5 or 6, the rotation rehabilitation treatment apparatus 200 gives stimuli to the user by vibrating the haptic devices 1 and 3 321 and 323 or the haptic devices 2 and 4 322 and 324 included in the vibration unit 210. Herein, the haptic devices 1 and 3 321 and 323 are installed at a left-upper end position and a right-lower end position corresponding to the counterclockwise direction in the body fixing band 310 in a diagonal direction. Contrary to this, the haptic devices 2 and 4 322 and 324 are installed at a right-lower end position and a left-upper end position corresponding to the clockwise direction in the body fixing band 310 in a diagonal direction.

First, referring to FIG. 5, the user recognizes that the rotation direction of the rehabilitation exercise is the counterclockwise direction, so that the user rotates the wrist in the counterclockwise direction. The user recognizes the vibration of the haptic devices 1 and 3 321 and 323 as power applied to the body, so that the user intuitively moves in an opposite direction (the counterclockwise direction) in which the power decreases.

In this case, the photography unit 230 motion captures a movement of the wrist of the user. Then, the data comparison unit 240 compares the motion-captured movement and a target wrist movement and feeds back a size of an error to the control unit 220. Then, the control unit 220 vibrates the haptic devices 1 and 3 321 and 323 until the movement error disappears, that is, until the user completes the rotation up to the target movement in the counterclockwise direction. Then, when the user completes the rotation up to the target movement, the control unit 220 stops the vibration of the haptic devices 1 and 3 321 and 323. In this case, the size of the vibrations of the haptic devices 1 and 3 321 and 323 are in proportion to the movement error.

In the meantime, as illustrated in FIG. 6, the user recognizes that the rotation direction of the rehabilitation exercise is the clockwise direction, so that the user rotates the wrist in the clockwise direction in a similar method to that of FIG. 5. The user recognizes the vibration of the haptic devices 2 and 4 322 and 324 as power applied to the body, so that the user intuitively moves in an opposite direction (the clockwise direction) in which the power decreases. The control unit 220 vibrates the haptic devices 2 and 4 322 and 324 until the movement error disappears, that is, until the user completes the rotation up to the target movement in the clockwise direction in a similar method to that of FIG. 5. Then, when the user completes the rotation up to the target movement, the control unit 220 stops the vibration of the haptic devices 2 and 4 322 and 324. In this case, the sizes of the vibrations of the haptic devices 2 and 4 322 and 324 are in proportion to the movement error.

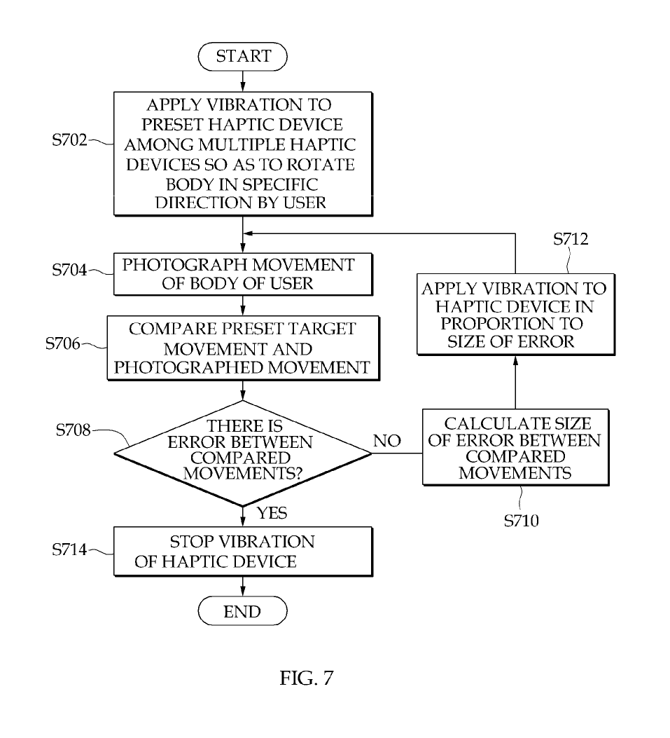

FIG. 7 is a flowchart illustrating an exemplary embodiment of a rotation rehabilitation treatment method using a vibration according to the present disclosure.

As illustrated in FIG. 7, the rotation rehabilitation treatment apparatus 200 applies a vibration to a preset haptic device among a plurality of haptic devices so that the user rotates the body in a specific direction (S720).

The rotation rehabilitation treatment apparatus 200 photographs a movement of the body of the user using a camera that is included (S704).

The rotation rehabilitation treatment apparatus 200 compares a preset target movement and the photographed movement, and applies the vibration in proportion to a size of an error to the haptic device (S706).

In this case, the rotation rehabilitation treatment apparatus 200 confirms whether there is an error between the compared movements (S708).

As a result of the confirmation in step S708, when there is an error between the compared movements, the rotation rehabilitation treatment apparatus 200 calculates a size of an error between the compared movements (S710).

The rotation rehabilitation treatment apparatus 200 applies the vibration to the haptic device in proportion to the size of the calculated error (S712). Then, the rotation rehabilitation treatment apparatus 200 performs the process from S704 of photographing the movement of the body of the user again.

However, as the result of the confirmation in step S708, when there is no error between the compared movements, the rotation rehabilitation treatment apparatus 200 stops the vibration of the haptic device (S714).

In the meantime, according to the present disclosure, the aforementioned rotation rehabilitation treatment method is implemented in a software program and is stored in a predetermined computer readable recording medium, so that the rotation rehabilitation treatment method may be applied to various reproduction devices.

The various reproduction devices may be an aforementioned user terminal, such as a mobile terminal, a PDA, a notebook computer, a navigation device, a PMP, a smart phone and an electronic dictionary.

For example, the recording medium may be a hard disc, a flash memory, a RAM and a ROM in an embedded form, or an optical disc, such as a CD-R and a CD-RW, a compact flash card, smart media, a memory stick and a multimedia card in an external form of each reproduction device.

In this case, the program recorded in the computer readable recording medium may be executed while including: a function of determining the rotation direction of the rehabilitation exercise according to the preset rehabilitation exercise data so that the user rotates the body; a function of vibrating the haptic device corresponding to the determined rotation direction of the rehabilitation exercise among the plurality of haptic devices which are attached to the body of the user so as to give different stimuli; and a function of stopping the vibration of the haptic device corresponding to the rotation direction of the rehabilitation exercise when the rotation of the body of the user in the determined rotation direction of the rehabilitation exercise is completed.

The present disclosure applies preset stimuli to a body of a user by using a vibration of the haptic device until the body of the user rotates up to a target point, thereby being capable of enabling the user to intuitively recognize a rotation direction of a rehabilitation exercise. In this sense, the present disclosure surpasses the limit of the existing technique, so that the present disclosure is an industrially applicable invention to the extent that the present disclosure may be realistically and obviously implemented, as well as the relevant technique is not only used, but also a marketability or a sale possibility of an apparatus to which the present disclosure is applied is sufficient.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An apparatus for a rotation rehabilitation treatment using a vibration, comprising:
a vibration unit comprising a plurality of haptic devices and configured to apply different vibrations according to a rotation direction of a rehabilitation exercise while being attached to a body of a user; and
a control unit configured to determine the rotation direction of the rehabilitation exercise according to preset rehabilitation exercise data so that the user rotates the body, vibrate a haptic device corresponding to the rotation direction of the rehabilitation exercise among the plurality of included haptic devices, and stop the vibration of the haptic device when a rotation in the rotation direction of the rehabilitation exercise is completed.

2. The apparatus of claim 1, further comprising:
a photography unit configured to photograph a movement of the body of the user; and
a data comparison unit configured to compare the photographed movement of the body and a body movement of the preset rehabilitation exercise data and feed back a movement error to the control unit.

3. The apparatus of claim 2, wherein the control unit determines a vibration level of the vibration unit in proportion to a size of the fed-back movement error.

4. The apparatus of claim 1, wherein the control unit vibrates the haptic device positioned in a diagonal direction corresponding to the determined rotation direction of the rehabilitation exercise.

5. A method for a rotation rehabilitation treatment using a vibration, comprising:
determining a rotation direction of a rehabilitation exercise according to preset rehabilitation exercise data so that a user rotates a body;
vibrating a haptic device corresponding to the determined rotation direction of the rehabilitation exercise among a plurality of haptic devices configured to apply different stimuli while being attached to the body of the user; and
stopping the vibration of the haptic device corresponding to the rotation direction of the rehabilitation exercise when a rotation of the body of the user in the determined rotation direction of the rehabilitation exercise is completed.

6. The method of claim 5, further comprising:
photographing a movement of the body of the user; and
comparing data by comparing the photographed movement of the body and a body movement of the preset rehabilitation exercise data and feeding back a movement error.

7. The method of claim 6, wherein the vibrating comprises determining a vibration level of the haptic device in proportion to a size of the fed-back movement error.

8. The method of claim 5, wherein the vibrating comprises vibrating the haptic device positioned in a diagonal direction corresponding to the determined rotation direction of the rehabilitation exercise.
